(19) United States
(12) Patent Application Publication
(10) Pub. No.: US 2002/0130011 A1
(43) Pub. Date: Sep. 19, 2002

(54) Coin processing machine having coin-impact surfaces made from laminated metal

(76) Inventors: Scott D. Casanova, Roselle, IL (US); Steven S. Kuhlin, Lake Zurich, IL (US); Richard J. Quinn, Crystal Lake, IL (US)

Correspondence Address: Stephen G. Rudisill, Jenkens & Gilchrist, P.C., 3200 Fountain Place, 1445 Ross Avenue, Dallas, TX, 75202-2799, US

(21) Appl. No.: 09/812,334

(22) Filed: Mar. 19, 2001

(51) Int. Cl. G07D 3/06; G07F 1/04

(52) U.S. Cl. 194/344; 453/3

(57) ABSTRACT

A coin processing machine of the present invention includes a coin input region for receiving said coins, a coin processing region for processing the coins, and a coin output region for receiving the coins that have been processed from the coin processing region. The processing machine includes a coin path leading from the coin input region, through the coin processing region, and into the coin output region. The coin path is partially defined by a coin-impact surface made of a laminated metal, preferably laminated steel. The laminated metal acts to absorb more of the energy for the impact of the coins and, thus, reduces the noise levels produced by coins.

### FIELD OF THE INVENTION

The present invention relates generally to coin processing devices and, more particularly, to a type of coin processing device that reduces the noise levels by employing laminated metal on coin-impacting surfaces.

### BACKGROUND OF THE INVENTION

Coin processing machines have been used for a number of years. There are several different types of processing machines. Coin sorters are used to sort coins of mixed denominations, usually so that each of the denominations can be counted. Coin wrappers receive coins of a particular denomination and arrange those coins in a stack so that a wrapping material, such as paper or plastic, can be placed around the coin stack. Coin redemption machines receive coins from a user and return to the user another item of value, such as paper currency, vouchers, or coupons. These coin processing machines may be large systems that are placed on the floor in banks, casinos, or retail stores. Alternatively, these machines may be of a smaller variety that fit on a countertop in one of these facilities.

One of the problems with these machines is the noise level produced by the handling of coins. The coins travel along paths through these machines that are defined by metallic surfaces. The repetitious impact of the coins on these metallic surfaces produces acoustical energy that transmits beyond the housing of the machine. When the machines are placed in an area populated with users or customers, the noise created by the impacting of coins on the metallic surfaces can attain a decibel level at which normal conversational speech becomes difficult.

Accordingly, the industries which commonly use coin processing machines are demanding machines that produce lower noise levels so that the machines do not disrupt business. Thus, a need exists for a coin processing machine that reduces the noise levels associated with the handling of the coins.

### SUMMARY OF THE INVENTION

A coin processing machine of the present invention includes a coin input region for receiving the coins and a coin processing region for processing the coins received by the coin input region. The coin processing region performs at least one coin processing function, such as sorting the coins into denominations, counting the coins, valuing the coins, discriminating the coins, and arranging the coins in a particular order. The coin processing machine further includes a coin output region for receiving the coins that have been processed from the coin processing region. Typically, the coin path leads from the coin input region through the coin processing region and into the coin output region. The coin path is partially defined by a coin-impact surface made of a laminated metal, preferably laminated steel. The laminated metal acts to absorb more of the energy for the impact of the coins and, thus, reduces the noise levels produced by the coins.

In one particular embodiment, the coin processing machine is a coin sorter. The coin sorter sorts coins into denominations. It includes an input coin path leading from a coin input region to a coin sorting region in which the coins are sorted into the denominations. Further, the coin sorter includes a plurality of output coin paths leading from the sorting region to output regions having coin receptacles. Each of the plurality of coin output paths is dedicated to one of the denominations. The input coin path can be defined by a coin-impact surface that is made of laminated metal. Alternatively, or in addition to the aforementioned laminated surface, one or more of the plurality of output coin paths is defined by a coin-impact surface made of laminated metal, preferably laminated steel.

### BRIEF DESCRIPTION OF THE DRAWINGS

The foregoing and other advantages of the invention will become apparent upon reading the following detailed description and upon reference to the drawings.

FIG. 1 is a cross-sectional view of a noise-deadening material that is used with various coin processing machines in the present invention.

FIG. 2 is a perspective view of a coin sorter system embodying the present invention.

FIG. 3 is a top plan view of the coin sorter system of FIG. 2.

FIG. 4 is an exploded perspective view of the primary components of the coin sorter system of FIG. 2.

FIG. 5 is a perspective view of the unitary base member, the sorting head, and the rotatable disc.

FIGS. 6A and 6B are top and bottom views, respectively, of the unitary base member in FIG. 5.

FIG. 7 is a bottom view of the sorting head that is used in the present invention.

FIG. 8 is a bottom perspective view of the coin sorter system illustrating the attachment of the coin bins.

FIG. 9 illustrates a manifold that is used to convert the path of sorted coins so as to be compatible with the till of a standard cash register.

FIGS. 10A and 10B illustrate side profiles of the coin paths when the coins are distributed into the coin bins and when the coins are distributed via the manifold of FIG. 9 to the till of a standard cash register.

FIG. 11 is a side view of an alternative coin-receiving region of a coin sorter that includes a coin chute and a coin bag holding assembly.

FIGS. 12A and 12B are perspective views of a coin bin assembly that is adapted to divert coins to a coin bag.

FIGS. 13A and 13B are an exploded perspective view and a perspective view, respectively, of an alternative base assembly similar to the one in FIGS. 6A and 6B.

FIG. 14 is an alternative coin chute that includes laminated materials.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

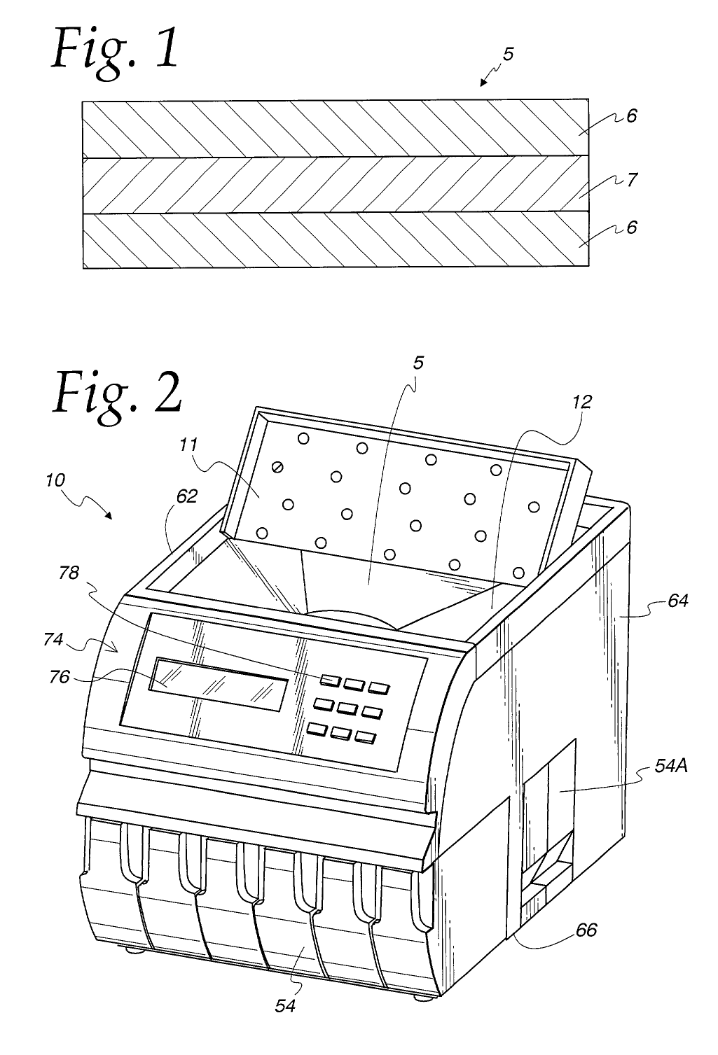

FIG. 1 illustrates a laminated material 5 having multiple layers. The outer two layers 6 are made of a metal, while the inner layer 7 is made of a non-metal that holds the outer two layers 6 together. The thin inner layer 7 of material 5 serves to dampen the vibrations of coins impacting the outer layers. The inner layer 7 converts the vibrational energy into thermal energy. The laminated material 5 comes in a variety of thicknesses, with the smallest one being about 0.04 inch and the largest being about 0.375 inch. Preferably, the laminated material 5 is a stainless steel. Such materials are available through various sources, including Classic Sheet Metal in Schiller Park, Ill.

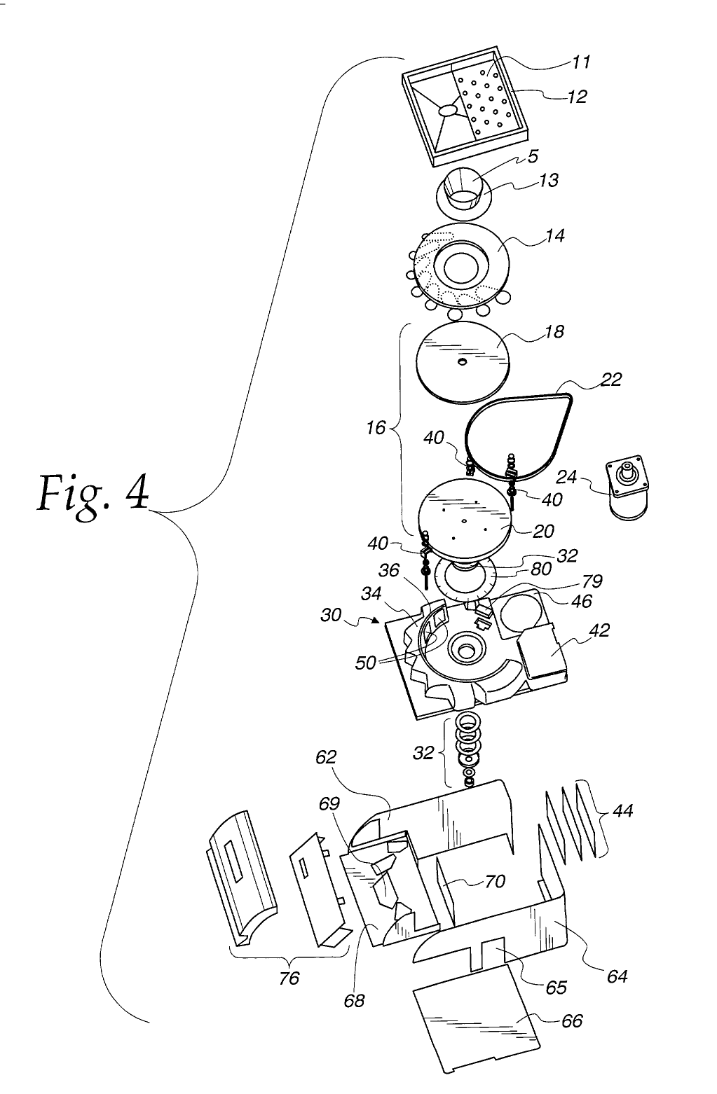

Turning now to the drawings of a coin processing machine, FIGS. 2-5 illustrate a coin sorter system 10 having several of its structures modified to include noise-deadening material, such as laminated material 5. In the coin entry region, the coin sorter system 10 includes a coin tray 12 which receives coins of mixed denominations and feeds them through a central coin hopper 13 into an opening in an annular sorting head 14 positioned below the coin tray 12. The coin tray 12 includes a pivotable section 11 which can be lifted by the operator to urge the coins downward towards the opening in the coin tray 12. Because of the sound caused by the coins impacting the surfaces of the coin entry region, the coin tray 12 and the hopper 13 include surfaces made with the laminated material 5 described in FIG. 1. These noise-deadening surfaces can be developed by attaching a sheet of the laminated surface 5 to these structures through fasteners or welding. Alternatively, the entire structure can be composed of the laminated material 5.

As the coins pass through the central opening of the sorting head 14, they are deposited on the top surface of a rotatable disc 16. The rotatable disc 16 comprises a resilient pad 18, preferably made of a resilient rubber or polymeric material, bonded to the top surface of a solid disc 20. While the disc 20 is often metal, it can be made of a rigid polymeric material, as well.

As the rotatable disc 16 rotates, the coins deposited on the top surface thereof tend to slide outward across the surface of the pad 18 of the rotatable disc 16 due to the centrifugal force. As the coins move outward, those coins which are lying flat on the pad 18 enter the gap between the upper surface of the pad 18 and the sorting head 14 because the underside of the inner periphery of the sorting head 14 is spaced above the pad 18 by a distance which is approximately as large as the thickness of the thickest coin. As further described below, the coins are sorted into their respective denominations and discharged from exit channels corresponding to their denominations.

The rotatable disc 16 is driven by a belt 22 which is connected to a motor 24. The motor 24 can be an AC or a DC motor. In a preferred embodiment, the motor 24 is a DC motor with the capability of delivering variable revolutions per minute (rpms). The direction of the current through the motor 24 can be changed such that the motor 24 can act upon the rotatable disc 16 to decelerate the disc 16, in addition to accelerating it. In an alternative embodiment, a braking mechanism connected to the motor or the rotatable disc 16 can assist in decelerating the rotatable disc 16.

A unitary base member 30 is the primary mounting structure for numerous components in the coin sorter system 10. A bearing assembly 32 for rotatably mounting the rotatable disc 16 is located within a recess on the underside of the unitary base member 30. The unitary base member 30 includes an uppermost surface 34 having a circular depression 36 which receives a flange on the periphery of the sorting head 14. Thus, the circular depression 36 allows the sorting head 14 to be concentrically aligned with the rotatable disc 16. The sorting head 14 is secured to the 15 unitary base member 30 with three fastening assemblies 40 positioned around the periphery of the sorting head 14. These three fastening assemblies 40, which can be manipulated by hand, also allow for the adjustment of the spacing between the sorting head 14 and the rotatable disc 16.

The unitary base member 30 includes an electronics region 42 into which printed circuit boards 44 are mounted. The printed circuit boards 44 contain the majority of the electrical components that control the operation of the coin sorting system 10. Additionally, the unitary base member 30 includes a motor mount region 46 where the motor 24 is attached.

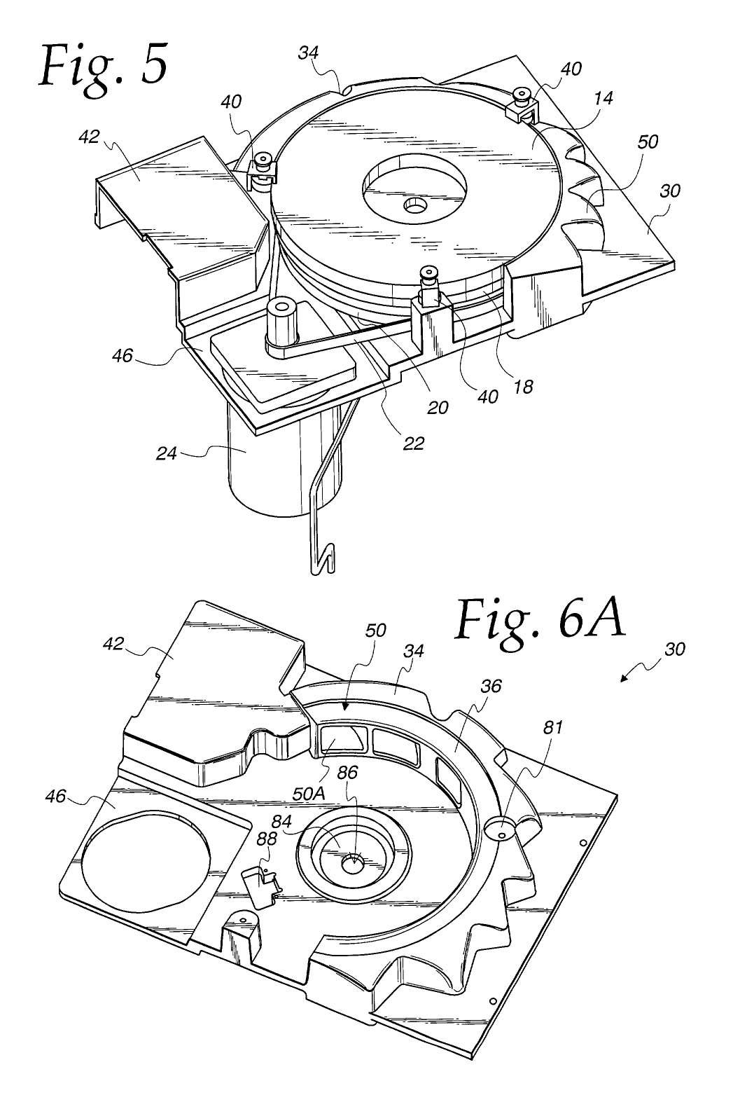

Because of the need for minimizing the size of the coin sorter system 10, the 25 unitary base member 30 includes a plurality of integral coin chutes 50. The integral coin chutes 50 receive the sorted coins as they exit the sorting head 14. The number of integral coin chutes 50 is typically the same for each coin sorting system 10, however, the number of coin chutes that are used in a particular coin sorting system 10 will vary depending on the number of coins in the coin set. As can be seen best in FIG. 5, the top of the coin chutes 50 is the uppermost surface 34 of the unitary base member 30.

As will be explained in detail later, the coins are sorted by their diameters within the sorting head 14, exit the sorting head 14 into a plurality of coin chutes 50, and are captured in a plurality of coin bins 54 positioned on the exterior of the coin sorter system 10. If the coin sorter system 10 is to be used for sorting only six denominations (like in the U.S. coin set), then only the six coin bins 54 located on the front of the coin sorter system 10 are used. Thus, the coin sorter system 10 can fit and operate within a footprint that is defined by length L′ and width W in FIG. 2, which will be discussed in more detail later. Alternatively, if the coin sorter system 10 is to be used for sorting eight denominations, then two additional coin bins 54a can be placed along the side of the coin sorter system 10.

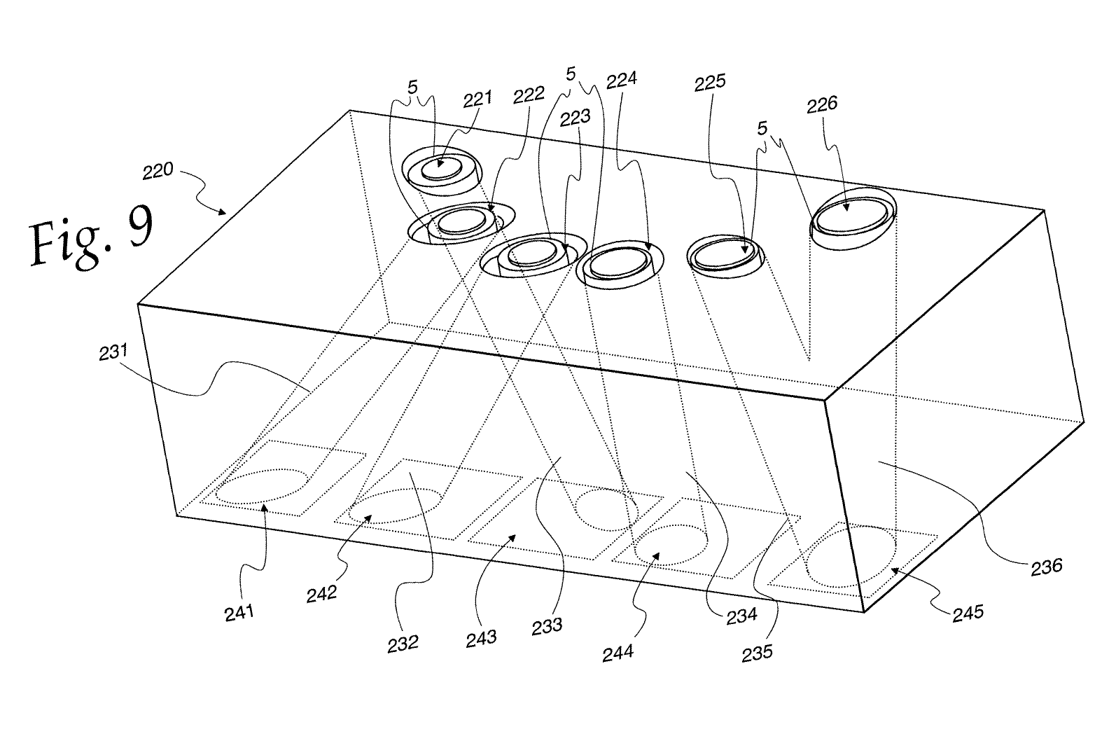

The coin bins 54 can be removed entirely from the coin sorter system 10 such that a till from a cash register or coin bags receives the sorted coins. The conversion of the coin sorter system 10 for use with a till of a cash register and for use with coin bags will be discussed with reference to FIGS. 9-11.

To provide a housing for the internal components, the coin sorter system 10 includes several walls. A left wall 62 and a right wall 64 form the sides of the coin sorter system 10. The right side wall 64 includes a cut-out 65 for insertion of the two side coin bins 54a, if these coin bins 54a are needed. The right and left side walls 62 and 64 wrap around the corners to also form a back wall. A floor 66 joins the two side walls 62 and 64 at their bases. An intermediate wall 68 also joins the two side walls 62 and 64 and is provided with a plurality of holes 69 which allow the coins to pass from the coin chutes 50 to the coin bins 54 positioned below the intermediate wall 68. The unitary base member 30 is mounted within the coin sorter system 10 and at least a portion of the unitary base member 30 is positioned over the intermediate wall 68. Below the intermediate wall 68 is a lower front wall 70 that is located between the two side walls 62 and 64. The lower front wall 70 is the surface against which the back of the coin bins 54 are positioned. To close the top of the coin sorter system 10, the coin tray 12 fits between the two side walls 62 and 64.

An operator control panel 74 is used by the operator to control the coin sorter system 10. The control panel 74 includes a display 76 for displaying information about the coin sorter system 10. The control panel 74 also includes keys 78, allowing the operator to enter information to the coin sorter system 10. The control panel 74 also serves a structural purpose in that it is the surface which closes the upper front portion of the coin sorter system 10. The control panel 74 may also include a touch screen device which provides more versatility to the operator when inputting information to the coin sorter system 10.

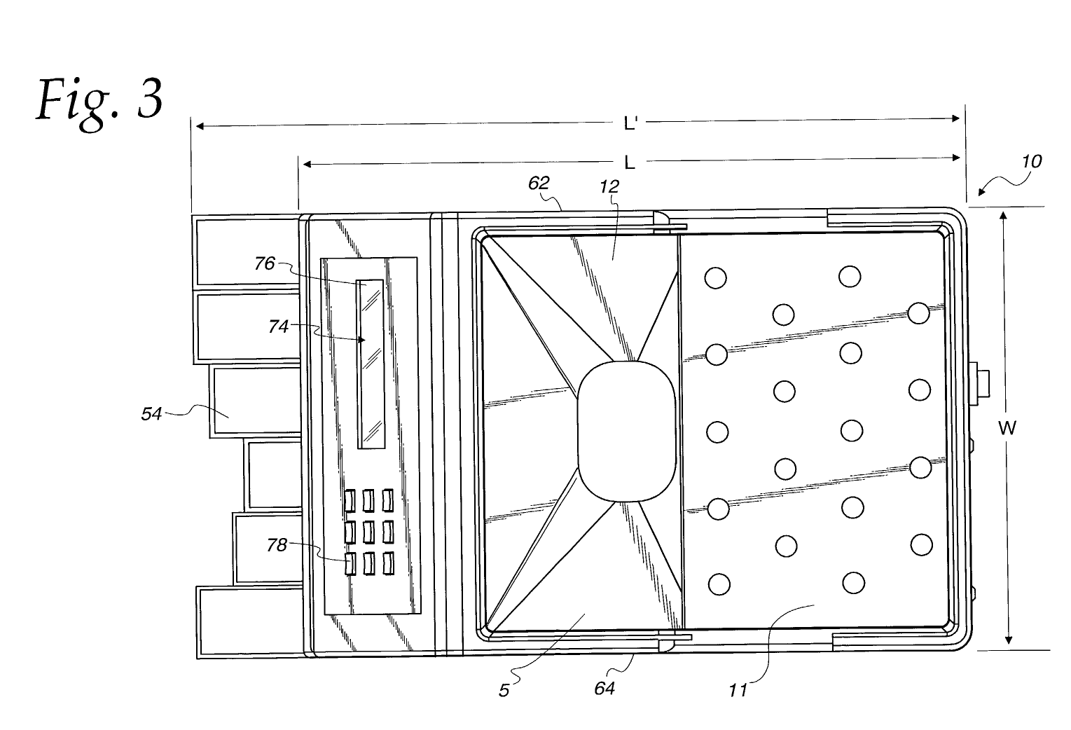

To track the angular movement of the rotatable disc 16 under the sorting head 14, the coin sorter system 10 may also include an encoder disc 80 (FIG. 3) that is mounted for rotation on the underside of the rotatable disc 16. The rotation of the encoder disc 80 is monitored by a stationary encoder sensor 79. Because the angular position of the rotatable disc 16 is continuously monitored, the locations of coins which have been sensed by sensors in the sorting head 14 can also be continuously monitored.

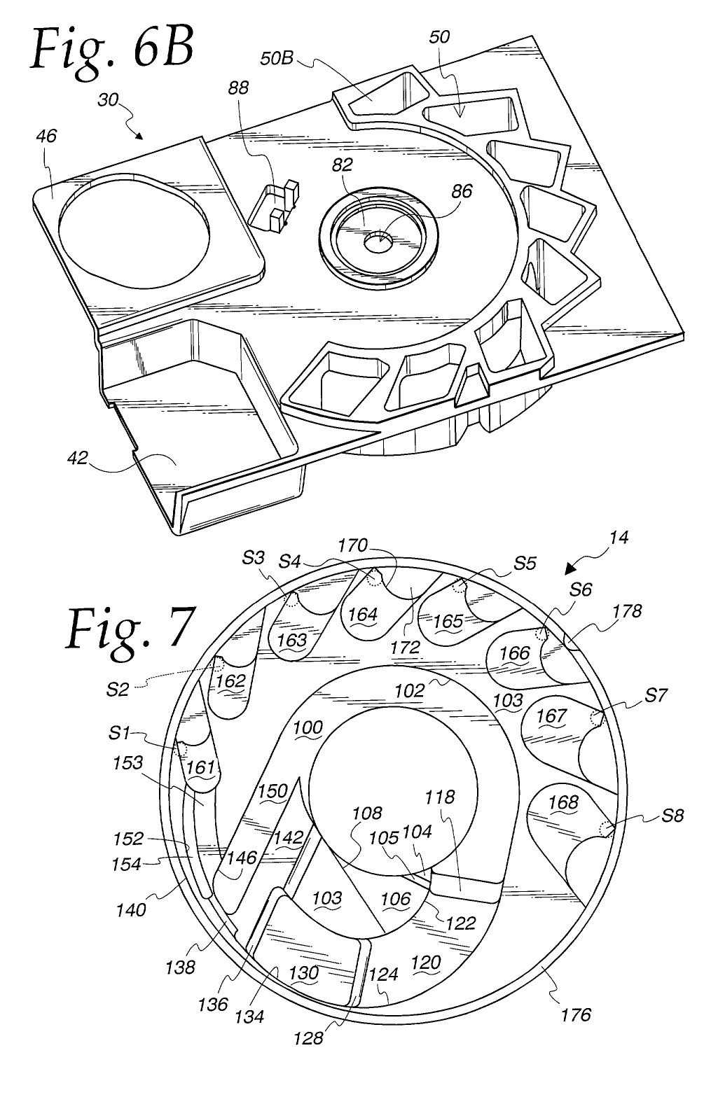

In FIGS. 6A and 6B, the details of the unitary base member 30 can be seen. As stated previously, the unitary base member 30 has several regions for mounting several components, such as the electronics mounting region 42 for the printed circuit boards 44 and the motor mount region 46 for the motor 24. The circular depression 36 in the uppermost surface 34 for registering the sorting head 14 extends more than 180° around the periphery of the sorting head 14. Because the rotatable disc 16 is rotatably fixed to the unitary base member 30, the sorting head 14 is automatically concentrically aligned over the rotatable disc 16 without the need for additional alignment tools, as is common in the prior art systems.

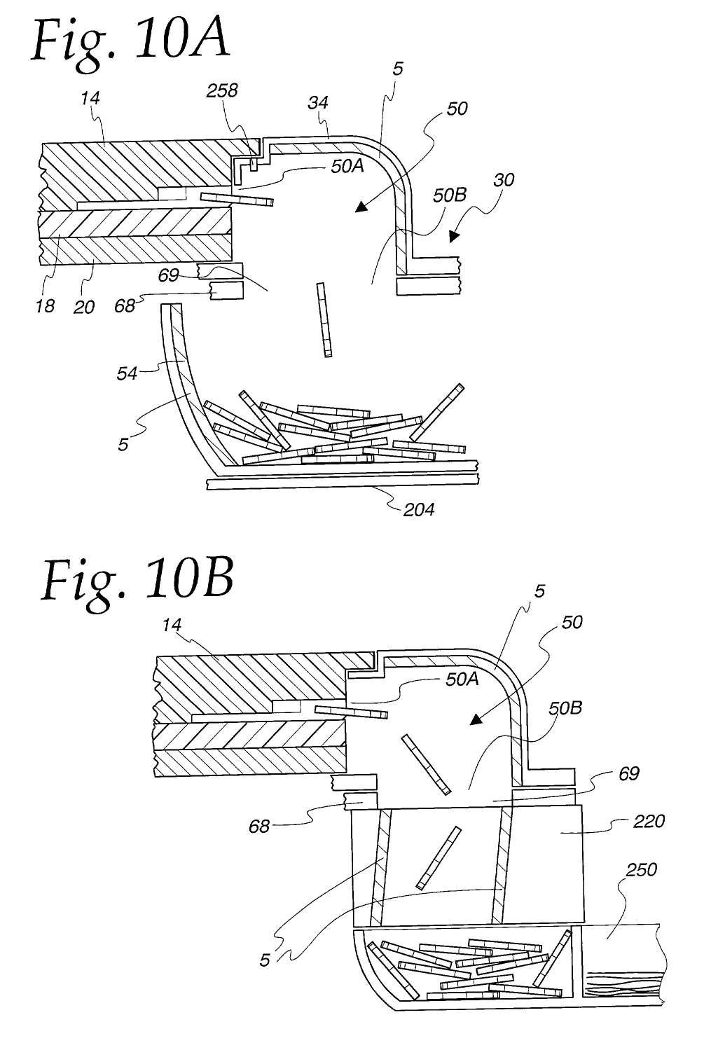

The unitary base member 30 can also be thought of as an integral eight coin chute. Each of the eight coin chutes 50 has an opening 50a which is parallel to the axis of rotation of the rotatable disc 16. The opening 50a receives the flow of coins as they exit the periphery of the sorting head 14. On the bottom side of the unitary base member 30, each of the coin chutes 50 has an exit aperture 50b through which the sorted coins are guided in a downward direction (as seen in FIG. 6B). In other words, the coin chutes 50 receive coins in their openings 50a having a generally horizontal trajectory and change the direction of the coins such that they leave exit apertures 50b with a vertical trajectory. The change of direction is caused by a coin-impact surface in the coin chutes 50. To reduce the noise associated with the impact of the coins, the inner wall of the coin chute 50 includes a piece of laminated material 5 that is described above in FIG. 1. This laminated material 5 is shown best in the cross-section through the coin chute 50 in FIG. 10A.

To move the coins into the coin bins 54 and 54a, the two exit apertures 50b closest to the electronics mount region 42 are vertically aligned with and dispense coins to the two side coin bins 54a (FIG. 2). Each of the remaining six exit apertures 50b is vertically aligned over a corresponding one of the front six coin bins 54 and dispenses coins thereto. Also, the plurality of holes 69 on the intermediate wall 68 are aligned with the six exit apertures 50b that dispense coins to the front six coin bins 54. It should be noted that there does not need to be six holes 69 to accommodate the six bins 54, but simply openings over the six paths leading from the exit apertures 50b to the coin bins 54. In other words, there could be one large hole 69 which would accommodate the coin paths for all six denominations.

The uppermost surface 34 of the unitary base member 30 also includes a circumferential registering notch 81 that mates with a corresponding structure on the sorting head 14. This ensures that the sorted coins from the sorting head 14 exit at the locations corresponding to the appropriate coin chute 50.

The bearing components 32 are mounted into a first circular recess 82 on the bottom side of the unitary base member 30 and a second circular recess 84 on the top side of the unitary base member 30. The bearing components 32 support the rotatable is disc 16 which includes a shaft that is inserted through a central hole 86 in the unitary base member 30. For proper concentric alignment of the rotatable disc 16 and the sorting head 14, the wall on the uppermost surface 34 which defines the circular recess 36 is located on a constant radius with respect to the central hole 86. Consequently, the circular recess 36 of the unitary base member 30 accurately registers the sorting head 14 concentrically over the rotatable disc 16, while the registering notch 81 circumferentially aligns the sorting head 14 with respect to the coin chutes 50.

If the coin sorter system 10 is configured with the encoder sensor 79 and the encoder disc 80, then the unitary base member 30 has an encoder sensor port 88. The encoder sensor 79 would fit into the port 88 and monitor the movement of the encoder disc 80 as it rotates with the rotatable disc 16.

The unitary base member 30 is made of a metal or a polymeric material. Thus, it can be formed through a molding process. If needed, the various holes and openings can be machined to result in the final unitary base member 30.

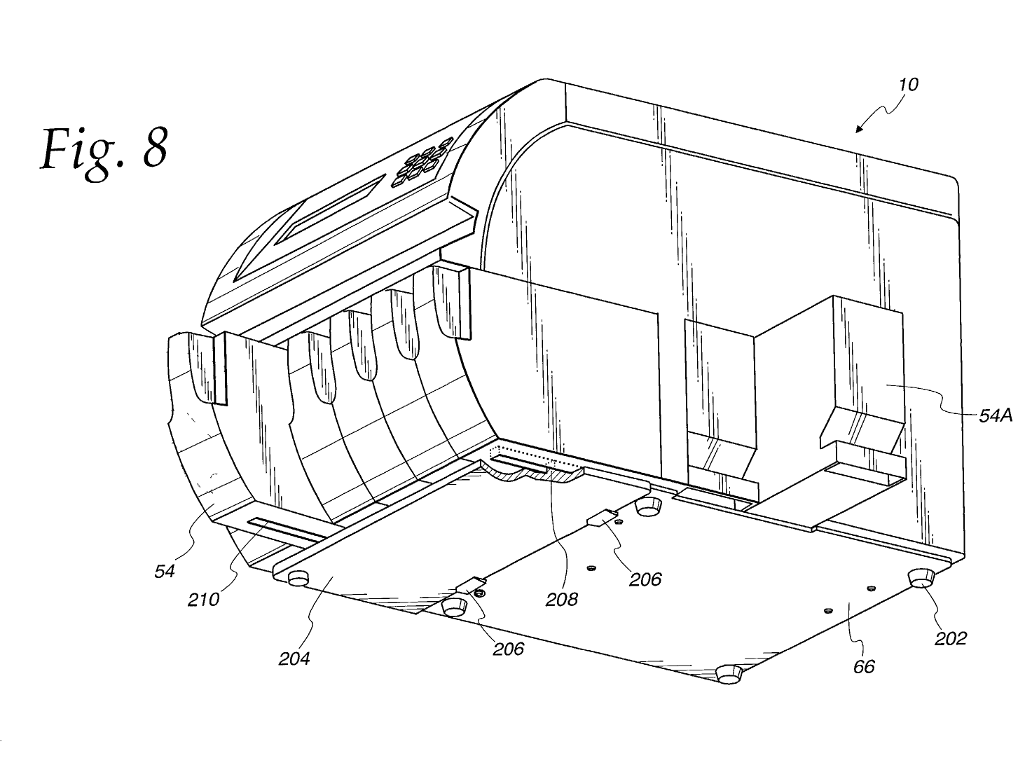

Referring now to FIG. 7, the coin sets for any given country are sorted by the sorting head 14 due to variations in their diameters. The coins circulate between the sorting head 14 and the pad 18 on the rotatable disc 16. The coins initially enter an entry channel 100 formed in the underside of the sorting head 14 after being deposited in the coin tray 12. It should be kept in mind that the circulation of the coins is clockwise in FIG. 7, but appears counterclockwise when viewing the coin sorter system 10 since FIG. 7 is a bottom view.

An outer wall 102 of the entry channel 100 divides the entry channel 100 from the lowermost surface 103 of the sorting head 14. The lowermost surface 103 is preferably spaced from the top surface of the pad 18 by a distance which is slightly less than the thickness of the thinnest coins. Consequently, the initial outward movement of all of the coins is terminated when they engage the outer wall 102 of the entry channel 100, although the coins continue to move circumferentially along the wall 102 by the rotational movement imparted on them by the pad 18 of the rotatable disc 16.

In some cases, coins may be stacked on top of each other. Because these stacked coins will be under pad pressure, they may not move radially outward towards wall 102. These stacked coins which are not against wall 102 must be recirculated. To recirculate the coins, the stacked coins encounter a separating wall 104 whereby the upper coin of the stacked coins engages the separating wall 104. The stacked coins are typically to the right (when viewing FIG. 7) of the lead edge of separating wall 104 when the upper coin engages the separating wall 104. While the separating wall 104 prohibits the further circumferential movement of the upper coin, the lower coin continues moving circumferentially across separating wall 104, along ramp 105, and into the region defined by surface 106 where the lower coin is in pressed engagement with the pad 18. Once in a pressed engagement with the pad 18 by surface 106, the recirculated lower coin remains in the same radial position, but moves circumferentially along the surface 106 until engaging recirculating wall 108 where it is directed towards the entry channel 100. The recirculating wall 108 separates surface 106 from a portion of the lowermost surface 103. The upper coin of the stacked coins, on the other hand, moves up ramp 118 and into a queuing channel 120.

Those coins which were initially aligned along wall 102 (and the upper coins of stacked coins which engage separating wall 104) move across the ramp 118 leading to the queuing channel 120. The queuing channel 120 is formed by an inside wall 122 and an outside wall 124. The coins that reach the queuing channel 120 continue moving circumferentially and radially outward along the queuing channel 120 due to the rotation of the rotatable disc 16. The radial movement is due to the fact that the queuing channel 120 has a height which is greater than the thickest coins, so coins are not in engagement with the queuing channel 120 and move outward on the pad due to the centrifugal force of rotation. The outside wall 124 of the queuing channel 120 prohibits the radial movement of the coins beyond the queuing channel 120. The queuing channel 120 cannot be too deep since this would increase the risk of accumulating stacked or “shingled” coins (i.e., coins having only portions which are overlapped) in the queuing channel 120.

In the queuing channel 120, if stacked or “shingled” coins exist, they are under pad pressure and tend to remain in the same radial position. Consequently, as the stacked or “shingled” coins move circumferentially and maintain their radial position, the inside wall 122 engages the upper coin of the “shingled” or stacked coins, tending to separate the coins. The lower coin often engages the surface 106, where it remains under pad pressure, causing it to retain its radial position while moving circumferentially with the pad 18. Thus, while the upper coin remains within queuing channel 120, the lower coin passes under the surface 106 for recirculation.

As these coins enter the queuing channel 120, the coins are further permitted to move outward and desirably engage the outside wall 124 of the queuing channel 120. The outside wall 124 of the queuing channel 120 blends into the outside wall 102 of the entrance region 100. After the coins enter the queuing channel 120, the coins are desirably in a single file stream of coins directed against the outside wall 124 of the queuing channel 120.

As the coins move circumferentially along the outside wall 124, the coins engage another ramp 128 which leads to a deep channel 130 where the coins are aligned against the outer wall 134. The outer wall 134 decreases in radius with respect to the central axis of the sorting head 14 when moving in clockwise direction. By decreasing the radius of exterior wall 134, the coins are encouraged to be aligned along the outer wall 134 such that they are in a single file line moving through the deep channel 130 along outer wall 134.

The coins which are aligned along outer wall 134 then move past ramp 136 onto narrow bridge 138. The narrow bridge 138 leads down to the lowermost surface 103 of the sorting head 14. At the downstream end of the narrow bridge 138, the coins are firmly pressed into the pad 18 and are under the positive control of the rotatable disc 16. Therefore, the radial position of the coins is maintained as the coins move circumferentially into a gauging region 140.

If any coin in the stream of coins leading up to the narrow bridge 138 is not sufficiently close to the wall 134 so as to engage the narrow bridge 138, then the misaligned coin moves into surface 142 and engages an outer wall 146 of a reject pocket 150. When the leading edge of the misaligned coins hit wall 146, the misaligned coins are guided back to the entry channel 100 for recirculation via the reject pocket 150.

To summarize, the coins which do not engage narrow ramp 138 can be generally placed into two groups: those coins which did not entirely proceed through the queuing channel 120, but instead proceeded past surface 106 back towards the center of the sorting head 14; and those coins that missed the narrow ramp 138 and subsequently moved into reject pocket 150.

The gauging region 140 includes a beveled surface 153 which transitions to a flat surface 154 which leads into a gauging wall 152. The gauging wall 152 decreases in its radial position in the clockwise direction. The coins are actually slightly tilted with respect to the sorting head 14 such that their innermost edges are digging into the pad 18 so as to be under positive pressure of the pad 18. In other words, due to this positive pressure on the innermost edges, the outermost edges of the coins tend to rise slightly away from the pad 18. Because the gauging region 140 applies a greater amount of pressure on the inside edges of the coins, the coins are less likely to bounce off the gauging wall 152 as the radial position of the coins is decreased along the length of the gauging region 140. Thus, the gauging region 140 ensures that the coins are held securely in the proper radial position defined by the gauging wall 152 as the coins approach the series of exit channels 161-168.

The gauging region 140 preferably extends for less than about 40° along the circumference of the sorting head 14. In other words, the arc length of the gauging wall 152 of the gauging region 140 is less than about 3 inches. As shown in the preferred embodiment of FIG. 7 where the sorting head 14 is about 8 inches in diameter and sorts eight coins, the gauging region 140 extends for about 30° of the circumference of the sorting head 14 and has a length of about 2 inches. While it was initially thought that the gauging region 140 must extend for a substantial length so that the radius of the gauging wall 152 decreased very gradually to ensure that coins did not bounce off the gauging wall 152, the applicants have found that a gauging region 140 where the radius of the gauging wall 152 decreases over a short length will produce positive results. By providing the gauging region 140 with such a profile, the coins do not bounce off the wall 152 and can quickly be aligned on the radius that is needed for sorting. Consequently, the diameter of an eight coin sorting head 14 can be made smaller than the sorting heads in previous coin sorter systems. Not only does this shrink the footprint of the coin sorting system 10, but reducing the diameter of the sorting head also decreases the weight of the system.

The first exit channel 161 is dedicated to the smallest coin to be sorted. Beyond the first exit channel 161, the sorting head 14 forms up to seven more exit channels 162-168 which discharge coins of different denominations at different circumferential locations around the periphery of the sorting head 14. Thus, the exit channels 161-168 are spaced circumferentially around the outer periphery of the sorting head 14 with the innermost edges of successive channels located progressively closer to the center of the sorting head 14 so that coins are discharged in the order of increasing diameter.

In the particular embodiment illustrated, the eight exit channels 161-168 are positioned to eject eight successively larger coin denominations, which is useful in foreign countries such as Germany and England which have an eight coin set. The sorting head 14 could also be configured to have only six exit channels by eliminating two channels such that the U.S. coin set (dimes, pennies, nickels, quarters, half dollars, and dollars) can be sorted. This can also be accomplished by using the sorting head 14 illustrated in FIG. 7 with a blocking element placed in two of the exit channels 161-168.

The innermost edges of the exit channels 161-168 are positioned so that the inner edge of a coin of only one particular denomination can enter each channel. The coins of all other denominations reaching a given exit channel extend inward beyond the innermost edge of that particular channel so that those coins cannot enter the channel and, therefore, continue on to the next exit channel under the circumferential movement imparted on them by the pad 18. To maintain a constant radial position of the coins, the pad 18 continues to exert pressure on the coins as they move between successive exit channels 161-168.

Each of the exit channels 161-168 includes a corresponding coin sensor S1-S8. The sensors S1-S8 are used to count the coins as the coins exit the exit channels 161-168. Thus, when the operator of the coin sorter system 10 places a batch of coins into the coin tray 12 and performs the necessary functions on the operator control panel 74 to begin the sorting process, the coin sorter system 10 has the capability of counting each of the coins in the batch and, thus, determining the monetary value of the batch. The sensors S1-S8 are also included so that the coin sorter system 10 can determine the number of coins that have been placed into a particular coin bin 54 to ensure that a coin bin 54 does not become over-filled. In this situation, the coin sorter system 10 will instruct the operator via the control panel 74 of the potential overfill problem.

The sensors S1-S8 may be discriminator sensors which determine whether the sensed coin is a slug. If the sensors S1-S8 are discriminator sensors, then they have the capability of both counting each coin and verifying the validity of each coin. Also, if the sensors S1-S8 are discriminator sensors, the system controller must be able to store validity data, such as magnetic patterns, and compare the detected pattern from each coin to the validity data. If a non-authentic coin is detected, the system may stop immediately and place a message on the control panel 74 which informs the operator that the coin bin 54 contains an invalid coin. Alternatively, the system may finish the coin batch and provide a summary to the operator at the end of the batch.

FIG. 8 illustrates the coin sorter system 10 in an isometric view which illustrates the bottom of the machine. The floor 66 of the coin sorter system 10 includes a plurality of mounts 202 which engage the surface on which the coin sorter system 10 is placed. A coin bin platform 204 is attached to the floor 66 via a plurality of fastening elements 206. Alternatively, the coin bin platform 204 may be integral with the floor 66 such that it is not removable from the floor 66. The coin bin platform 204 includes six parallel projections 208 which engage corresponding slots 210 in the coin bins 54. Accordingly, the operator of the coin sorter system 10 can easily remove one of the coin bins 54 from the coin bin platform 204 and reinsert it. In a similar fashion, the side coin bins 54a also may include slots which engage projections on the top side of the floor 66 so that the side coin bins 54a can be easily manipulated by the operator of the coin sorter system 10.

The operator of the coin sorter system 10 may, however, decide that the coin bins 54 are not needed and, instead, the sorted coins must be directed into the cash till of a typical cash register. Because the coins are sorted based on their diameters, not on their value, it is necessary to distribute the sorted coins into a pattern that coincides with the coin receptacle locations in a cash till of a cash register. In the U.S., the typical cash register has coin receptacles in which coins are placed in a manner of increasing value. In fact, most cash tills for cash registers use just one coin receptacle for both the half-dollar and dollar since they are used fairly infrequently. Thus, the standard U.S. cash register has only five coin receptacles.

To convert the coin sorter system 10 into a system which places coins into a cash till of a standard retail cash register, the coin sorter system 10 is required to include a manifold 220 as shown in FIG. 9. If the coin bin platform 204 is of the type that requires removal to insert the manifold 220, then the coin bin platform 204 should be removed from the floor 66 of the coin sorter 10 by removing the fastening elements 206. The manifold 220 in FIG. 9 is then fixed to the coin sorter system 10, preferably by hard manipulating fasteners. If the coin bin platform 204 is of the type that is not removable from the floor 66, the manifold 220 may include a lower structure that allows it to slide into the projections 208.

The manifold 220 includes six inlets 221-226 which receive coins in the order of the diameters of the coins. In other words, when manifold 220 is used with the U.S. coin set, inlet 221 receives dimes, inlet 222 receives pennies, inlet 223 receives nickels, inlet 224 receives quarters, inlet 225 receives dollars, and inlet 226 receives half-dollars. But to place these coins in ascending value in a coin till, it is necessary to rearrange the flow of these coins along their respective coin paths. Accordingly, from the inlets 221-226, the coins travel down particular coin paths 231-236 which lead to only five outlets 241-245. Consequently, dimes enter inlet 221 and pass down path 233 to outlet 243. Pennies enter inlet 222 and pass down path 231 to outlet 241. Nickels enter inlet 223 and pass down path 232 to outlet 242. Quarters enter inlet 224, pass through path 234, and exit through outlet 244. Dollars and half-dollars enter inlets 225 and 226, respectively, pass through paths 235 and 236, respectively, and enter into the same outlet 245. Because of the number of coins that are sent through the manifold 220, the impact of the coins on the paths 231-236 can be quite noisy. Thus, the paths 231-236 in the manifold 220 can include the laminated material 5.

FIGS. 10A and 10B illustrate a side view which compares the coin path of coins as they exit the sorting head 14 when the coin bins 54 are in use and when the manifold 220 is in use with a cash till 250, respectively. In FIG. 10A, the coins exit the sorting head 14 and move into the chute opening 50a of the coin chute 50. The coins then move entirely through the coin chute 50 and exit through the exit aperture 50b, whereupon they pass through the hole 69 in the intermediate wall 68. After moving past the intermediate wall 68, the coins of a particular denomination then encounter the coin bin 54 for that denomination. FIG. 10A also illustrates an alternative embodiment for sensing the coins where a coin sensor 258 is located just outside the sorting head 14.

As shown in FIG. 10A, the laminated material 5 is located in the coin chute 50 to deaden the noise that occurs as the coins impact the wall of the coin chute 50. Further, the coin bin 54 includes the laminated material 5 to lessen the noise from the coins impacting the coin bin 54.

FIG. 10B illustrates the coin path as the coins exit the sorting head 14 and are placed into the retail cash till 250. The coins exit the periphery of the sorting head 14 and rotatable disc 16 and enter the coin chute 50 located in the interior base member 30. The coins pass through the chute opening 50a into the coin chute 50 and move through the exit aperture 50b before encountering the opening 69 in the intermediate wall 68. Unlike the configuration illustrated in FIG. 10A, the coins then pass through the corresponding coin path in the manifold 220, which includes the laminated material 5 to reduce sound, and enter the corresponding coin bin in the cash till 250.

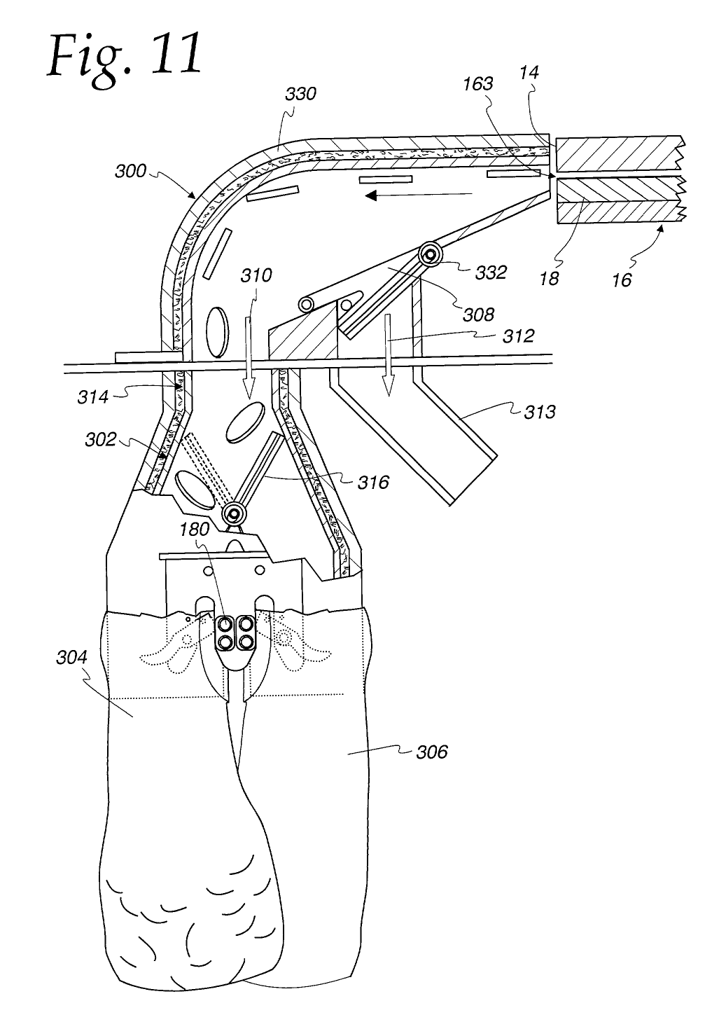

FIG. 11 illustrates a coin chute assembly 300 that is different from the previous coin chutes in that it is not integral with the structure on which the sorting head 14 is mounted. The coin chute assembly 300 cooperates with a bag clamping mechanism 302 to deliver coins from the sorting region of the coin sorter system 10 to the coin receptacles which, in this case, are coin bags 304 and 306.

After the coins are discharged from an exit channel 163 of the sorting head 14, the coins enter the coin chute 300. If the coin is detected to be a valid coin, the flipper 308 of the coin chute 300 remains in the lower position (as shown) and the coin continues down first chute 310. Alternatively, if the coin is detected to be an invalid coin, the flipper 308 of the coin chute 300 raises upward to deflect the invalid coin towards second chute 312. Preferably, each coin chute 300 has a tube, like tube 313, which discharges invalid coins to one common invalid coin collector.

When a valid coin passes through first chute 310 of the coin chute 300, the coin enters the upper portion 314 of bag clamping mechanism 302 where it encounters a flipper 316. The coin then proceeds down either one of two paths into the left bag 304 or the right bag 306. If the flipper 316 is in the position shown with solid lines, the coin enters left bag 304. Once the left bag 304 has reached its maximum limit of coins, the flipper 316 moves to the position shown by the phantom lines and the coins enter right bag 306. Preferably, the operator then removes the left bag 304 and replaces it with an empty bag before the right bag 306 becomes full. The bags 304 and 306 are held on the coin chute 314 with bag clamping mechanisms 322 and 324.

The path of the coin as it exits the sorting head 14 is usually substantially horizontal. But, given the configuration of the bag clamping mechanism 302, the coin path then turns substantially vertical. The coin chute assembly 300 assists in the changing of the coin path from horizontal to vertical.

To reduce noise in the coin-receiving region of the coin sorting machine, the coins chute assembly 300 includes a wall 330 made of laminated metal. Further, the inner surface 332 of the discrimination flipper 308 that is impacted with coins may also include laminated metal to reduce noise. Likewise, the flipper 316 that directs the coins between bags 304 and 306 can be made of laminated metal such that each side of the flipper 316 is one of the metal layers comprising the laminated metal. Further, the bag clamping mechanism 302 is defined by walls of laminated metal. Accordingly, the coin-receiving region that is beyond the coin sorting region includes various structures having noise-deadening materials to reduce the noise levels of the coin sorting system 10.

It should be noted that the inclusion of laminated metal in the coin processing machine may be like FIG. 11, where the structures having the surfaces defining the coin path are made entirely of laminated metal. Alternatively, as shown in FIGS. 10A-10B, the laminated metal 5 is added to an existing structure in the system. Further, FIGS. 10A-10B and 11 illustrate a region where a constant stream of coins exits the sorting head 14 at a high rate of speed. Due to the force of impact, the laminated metal is preferably laminated stainless steel since the stainless steel provides more rigidity and will deform less under the constant impact of the coins.

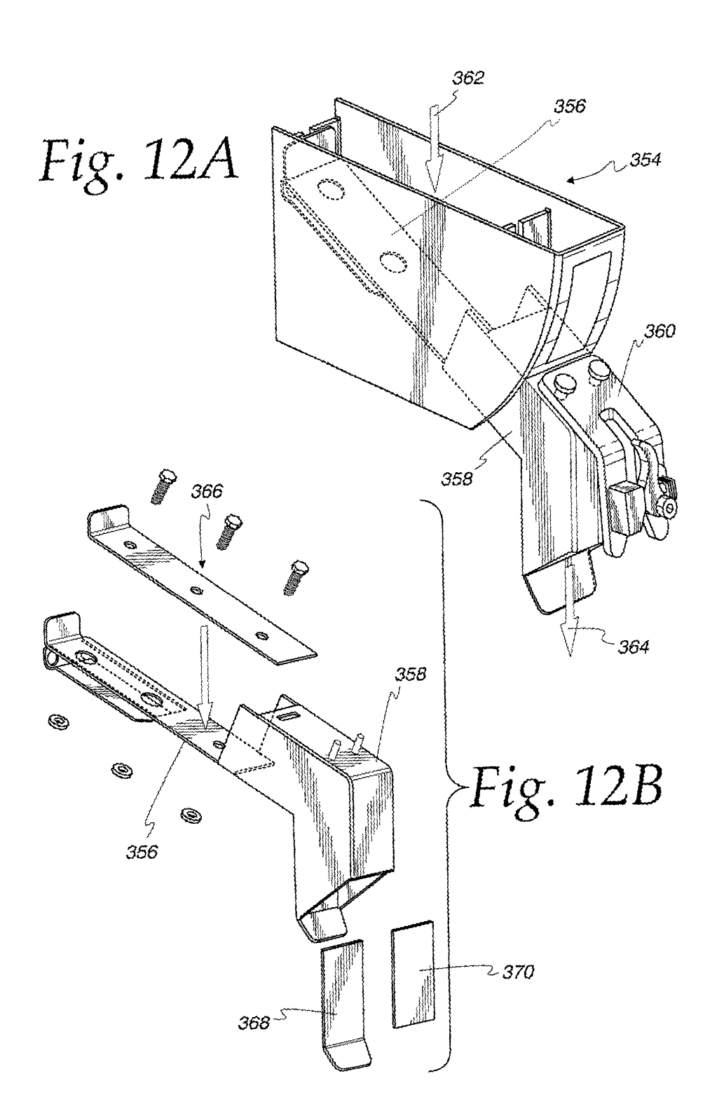

FIG. 12A illustrates a box-to-bag converter 354 that can be used in the coin sorter system 10. Thus, the operator of the coin sorting system 10 can remove one of the coin bins 54 and replace it with the box-to-bag converter 354. The converter 354 includes a ramp 356 that leads towards a coin chute 358 at the lower front of the converter 354. The coin chute 358 changes the trajectory of the coins traveling along the angled ramp 356 to a downward direction. The coin chute 358 includes a bag holder 360 for holding a bag tightly around the chute 358. Accordingly, coins travel from a coin input 362 at the upper rear portion of the converter 354 to a coin output 364 at the lower front portion of the converter 354.

FIG. 12B illustrates the locations of the laminated metal in the box-to-bag converter 354. A laminated ramp portion 366 is bolted to the ramp 356 to reduce the noise associated with the coins impacting the ramp 356. Further, a pair of laminated inserts 368, 370 are placed in the coin chute 358 to reduce the noise associated with coins bouncing within the coin chute 358. The coin sorter system 10 may include several of these box-to-bag converters 354 having laminated metal to reduce the noise from the impact of the coins. Furthermore, the coin sorter system 10 may include other alternative coin directing assemblies that receive coins from a sorting region and deliver coins to the coin receptacles. Such assemblies can be improved by the addition of this noise-deadening, laminated material.

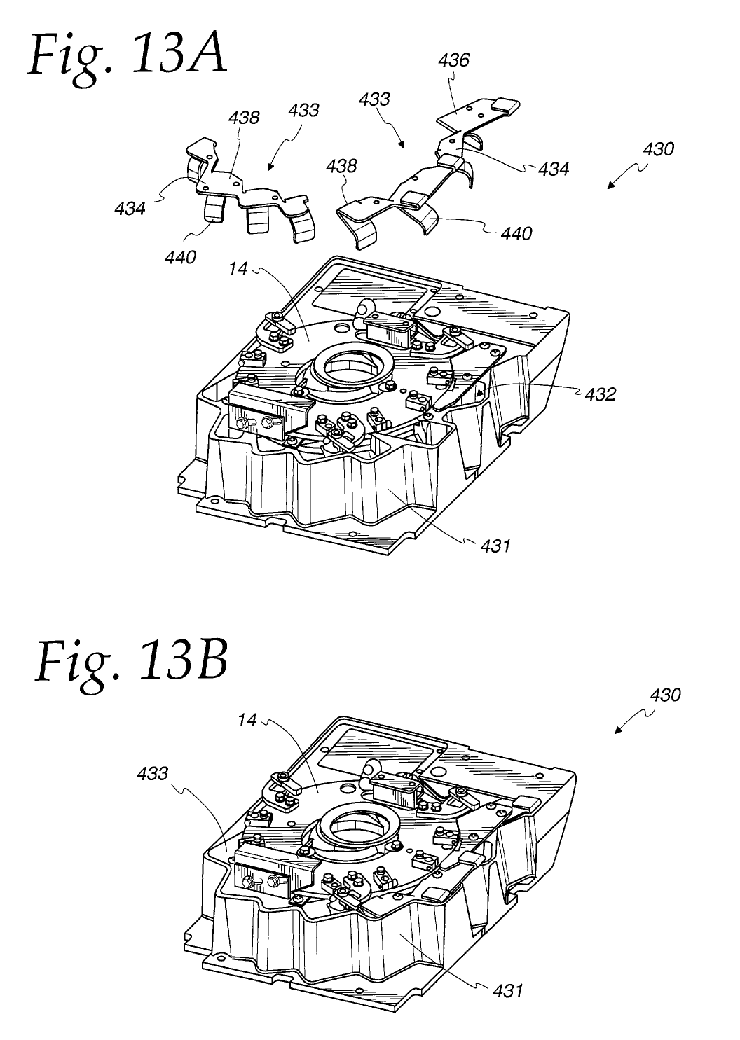

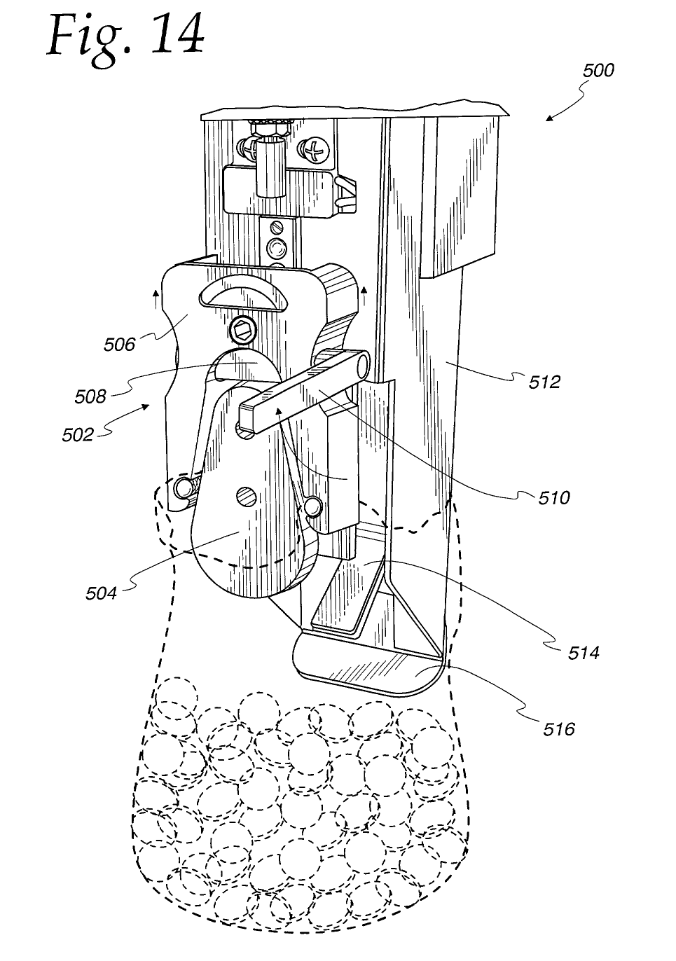

FIGS. 13A and 13B illustrate an alternative base member 430 that is similar to the base member 30 in FIGS. 6A and 6B. The base member 430 includes coin chutes 431 that receive coins from the sorting head 14. The coin chutes 431 have a top opening 432 that receives a coin tipper assembly 433. The coin tipper assembly 433 includes a flat upper section 434 that fits over the top openings 432. The upper section 434 includes several holes 436 that receive fasteners for holding the coin tipper assembly 433 on the base member 430.

The upper section 434 includes a joint 438 that leads to a deflecting section 440. The joint section 438, in this embodiment, is simply a bend in the material comprising the coin tipper assembly 433. The deflecting section 440 is engaged by the coins as they leave the sorting head 14 and directs the coins downward towards the coin chutes 431. Because of the joint 438, the deflecting section 440 is fixed at one end and free at the other end. Hence, the deflecting sections 440 will move when impacted by the coins. Because of the eight coin chutes 431, two coin tipper assemblies 433, each having four deflecting sections 440, are shown.

The coin tipper assembly 433 is made of laminated metal to help reduce the noise associated with coins impacting the deflecting section 440. Furthermore, because of the movement of the deflecting sections 440 due to the joint 438, the noise level is further reduced because the mechanical energy of the claim is converted to kinetic energy in the deflecting sections 440.

As an example of the improvement achieved by the coin tipper assembly 433 made of laminated metal, a sound test was conducted using a coin tipper assembly made of a laminated steel and one made of standard cold-rolled, zinc-plated steel. The machine used was a Model 1000 Coin Sorter form Cummins-Allison that has a configuration very similar to that which is shown in FIGS. 2-4. The acoustic sensor was a Type 2230 sensor from Bruel & Kjaer. The sensor was placed approximately 2 feet away from and 1 foot above the coin sorting machine. The coins used in the test were U.S. half-dollars (i.e., large and heavy coins), processed at a rate of 500 coins per minute. The sound level produced by the machine incorporating the laminated steel for the coin tipper assembly 433 was 2-3 dB less than the machine having the standard steel coin tipper assembly. It is expected that the addition of laminated metal to other portions of the coin path of the machine having the coin tipper assembly 433 made of laminated steel will result in even a further reduction in sound levels.

FIG. 14 illustrates an alternative coin chute assembly 500 that includes a bag clamping mechanism 502 that is described in detail in U.S. Pat. No. 6,131,625, which is incorporated herein by reference in its entirety. The bag clamping mechanism 502 includes a stationary member 504 and a moving member 506. The moving member 506 moves relative to the stationary member 504 by the use of a cam 508 having a handle 510.

The coin chute assembly 500 preferably includes walls 512 having laminated metal at least on the inside surface to reduce the sound from the coins. In this embodiment, the entire wall 512 is made of laminated metal. Further, the coin deflecting portions 514 and 516 at the bottom of the assembly 500 are also made of laminated metal.

Thus far, the present invention has been described with reference to the coin sorter system 10. The laminated materials that reduce noise levels in the coin sorter system 10, however, can be used in any coin processing machine. For example, the laminated metal could be used in a coin wrapping machine which receives coins in a coin hopper, transfers the coins to a stacking region where the coins are stacked, transfers the stacked coins to a wrapping region where coins are wrapped, and releases the wrapped coins to coin receptacles. In such a wrapping system, there are several locations where coins are impacting surfaces. By placing the laminated metal on these coin-impact surfaces, the coin wrapping system has a reduced noise level.

There are also coin counting machines that simply count the number of coins of a certain denomination. The coins are usually moved at high speeds through these coin counting machines. As would be expected, the high speed coins engage several surfaces along the coin path. Placement of the laminated metal on these impact surfaces can reduce the noise in such a coin counting system.

Similarly, coin redemption machines receive coins from a user and return to the user a cash equivalent related to the amount that the user has deposited into the machine. The cash equivalent can be, for example, paper money, a voucher, or a credit on a Smartcard. Because these coin redemption machines must count the coins quickly to return the cash equivalent to the user, the surfaces along the coin path in these machines can include laminated metal to reduce the noise associated with the impact of the coins upon the surfaces. Also, many currency redemption machines accept both paper money and coins to provide the user with a cash equivalent. Placement of laminated metals along the coin path in these currency redemption machines reduces the noise levels associated with the processing of the coins therein.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method of reducing sounds in a coin processing machine having a coin path leading from a coin input region, through a coin processing region, and to a coin output region for receiving processed coins, comprising:
defining a portion of said coin path with a laminated metal.

2. The method of claim 1, wherein said defining includes attaching said laminated material to a wall defining said coin path at a point where said coins repetitiously impact said wall.

3. The method of claim 2, wherein said attaching includes welding said laminated material.

4. The method of claim 1, wherein said portion of said coin path is within said coin input region.

5. The method of claim 1, wherein said portion of said coin path is within said coin output region.

6. A method of operating a coin processing machine having a coin path leading from a coin input region, through a coin processing region, and to a coin output region, comprising:
moving coins along said coin path; and
impacting coins on structures defining said coin path at points where laminated metal is located.

7. The method of claim 1, wherein said moving includes moving coins across a sorting head with a rotating disc.

8. The method of claim 1, wherein one of said structures is fixed at one end and free at another end so that it can be deflected.

9. The method of claim 1, wherein said laminated metal is laminated steel.

10. A coin sorter for sorting coins of mixed denomination, comprising:
a coin entry region for receiving said coins, said coin entry region having a coin-impact surface made of a laminated metal for reducing noise;
a coin sorting region for separating said coins into denominations; and
a coin-receiving region for receiving sorted coins from said sorting region and having receptacles dedicated to particular denominations of said coins.

11. The coin sorter of claim 10, wherein said coin entry region includes a coin hopper, said coin hopper having said coin-impact surface made of said laminated metal.

12. The coin sorter of claim 11, wherein said coin-impact surface made of said laminated metal is generally horizontal.

13. The coin sorter of claim 10, wherein said coin-impact surface made of said laminated metal is angled with respect to vertical.

14. The coin sorter of claim 10, wherein said coin entry region includes a pivotable tray capable of being moved to guide said coins towards an opening leading to said coin sorting region, said pivotable tray having said coin-impact surface made of said laminated metal.

15. The coin sorter of claim 14, wherein said coin entry region further includes a hopper adjacent to said pivotable tray, said coin hopper also including a surface with laminated metal.

16. The coin sorter of claim 10, wherein said coin-impact surface has a generally tubular cross-section.

17. The coin sorter of claim 16, wherein said generally tubular cross-section is circular.

18. The coin sorter of claim 10, wherein said coin sorting region includes a stationary sorting head and a rotating disc imparting motion to said coins.

19. The coin sorter of claim 18, wherein said coin-impact surface is located above said sorting head and guides coins to an opening in said stationary sorting head.

20. A coin sorter for sorting coins of mixed denomination, comprising:
a coin entry region for receiving said coins;
a coin sorting region for separating said coins into denominations; and
a coin-receiving region for receiving sorted coins from said sorting region and having receptacles dedicated to particular denominations of said coins, said coin-receiving region including a coin-impact surface made of laminated metal.

21. The coin sorter of claim 20, wherein said coin-receiving region includes a coin chute for guiding said sorted coins towards said receptacles, said coin chute having said coin-impact surface made of laminated metal.

22. The coin sorter of claim 21, wherein said coin-impact surface guides said coins between a horizontal and a vertical direction.

23. The coin sorter of claim 22, wherein said coin-impact surface is curved.

24. The coin sorter of claim 22, wherein said coin-impact surface is mounted on one end and is capable of deflecting under impact of said coins.

25. The coin sorter of claim 24, wherein said laminated metal is laminated stainless steel.

26. The coin sorter of claim 21, wherein said coin chute includes a coin-directing flipper, said coin directing flipper including said laminated metal.

27. The coin sorter of claim 20, wherein said coin-receiving region includes a coin bag holding assembly, said coin-impact surface being located in said coin bag holding assembly.

28. The coin sorter of claim 20, wherein said coin-impact surface is capable of deflecting under impact of said coins.

29. The coin sorter of claim 20, wherein said coin-receiving region includes a rigid coin receptacle, said rigid coin receptacle including said coin-impact surface made of laminated metal.

30. A coin sorter for sorting coins of mixed denominations, comprising:
an input coin path leading from a coin input region to a coin sorting region in which said coins are sorted into said denomination; and
a plurality of output coin paths leading from said sorting region to an output region having coin receptacles, each of said plurality of output coin paths being dedicated to one of said denominations, at least one of said plurality of output coin paths being defined by a coin-impact surface made of laminated metal.

31. The coin sorter of claim 30, wherein each of said plurality of output paths includes a coin-impact surface made of a laminated metal.

32. The coin sorter of claim 30, wherein said laminated metal is laminated steel.

33. The coin sorter of claim 30, wherein said coin-impact surface made of laminated metal has one fixed end and one free end such that said coin-impact surface deflects under an impact of a coin.

34. The coin sorter of claim 33, wherein said coin-impact surface made of laminated metal is curved for deflecting said coins downward.

35. The coin sorter of claim 34, wherein said fixed end is at an uppermost end.

36. The coin sorter of claim 30, wherein said coin-impact surface made of laminated metal moves coins directly into said coin receptacle.

37. The coin sorter of claim 30, wherein said coin-impact surface made of laminated metal moves coins from a generally horizontal trajectory to a generally vertical trajectory.

38. The coin sorter of claim 30, wherein one of said coin receptacles is a bag, said coin-impact surface made of laminated metal being located within a bag holding assembly.

39. The coin sorter of claim 30, wherein said coin-impact surface made of laminated metal is within one of said receptacles.

40. A coin sorter for sorting coins of mixed denominations, comprising:
an input coin path leading from a coin input region to a coin sorting region in which said coins are sorted into said denomination, said input coin path being defined by a coin-impact surface made of laminated metal; and
a plurality of output coin paths leading from said sorting region to an output region having coin receptacles, each of said plurality of coin output paths being dedicated to one of said mixed denominations.

41. The coin sorter of claim 40, wherein said laminated metal is on a coin hopper.

42. The coin sorter of claim 40, wherein said laminated metal is on a coin tray.

43. The coin sorter of claim 42, wherein said tray is a pivotable coin tray.

44. The coin sorter of claim 40, wherein said laminated metal is a laminated steel.

45. A machine for processing coins, comprising:
a coin input region for receiving said coins;
a coin processing region for processing said coins, said coin processing region performing at least one of the functions consisting of sorting said coins, counting said coins, discriminating said coins, and arranging said coins in a particular order;
a coin output region for receiving coins processed from said coin processing region; and
a coin path leading from said coin input region through said coin processing region and to said coin output region, said coin path being partially defined by a coin-impact surface made of a laminated metal.

46. The coin processing machine of claim 45, wherein said coin processing machine is a coin sorting machine for sorting said coins into denominations.

47. The coin processing machine of claim 45, wherein said coin processing machine is a coin wrapping machine for wrapping said coins in a holding material.

48. The coin processing machine of claim 45, wherein said coin processing machine is a coin redemption machine for redeeming said coins for another item of value.

49. The coin processing machine of claim 45, wherein said coin processing machine is a currency processing machine for receiving coins and paper currency.

50. A coin processing machine for processing coins, comprising:
a coin entry region for receiving said coins;
a processing region for processing said coins;
an output region for receiving sorted coins from said processing region; and
means in at least one of said regions for reducing noise from said coins, said noise reducing means including a laminated material.

51. The coin processing machine of claim 50, wherein said laminated material is a laminated metal.

52. The coin processing machine of claim 51, wherein said laminated metal is a laminated steel.

53. The coin processing machine of claim 51, wherein said laminated metal is a laminated stainless-steel.
